(19) United States
(12) Patent Application Publication
(10) Pub. No.: US 2026/0276583 A1
(43) Pub. Date: Sep. 17, 2026

(54) ANALYSIS METHOD AND CAPILLARY ELECTROPHORESIS DEVICE

(71) Applicant: Hitachi High-Tech Corporation, Minato-ku, Tokyo (JP)

(72) Inventors: Asami TERAKADO, Tokyo (JP); Motohiro YAMAZAKI, Tokyo (JP); Hirokazu KATO, Tokyo (JP); Noriyuki SUMIDA, Tokyo (JP); Hiroyuki TANAI, Tokyo (JP)

(21) Appl. No.: 18/873,963

(22) PCT Filed: Jul. 27, 2022
(86) PCT No.: PCT/JP2022/028984

§ 371 Date: Dec. 11, 2024

(51) Int. Cl. G01N 27/447

(52) U.S. Cl. CPC G01N 27/44743; G01N 27/44717; G01N 27/44756

(57) ABSTRACT

An object of the invention is to provide an analysis method, in which unnecessary re-electrophoresis and sample repreparation are suppressed. To this end, the invention includes a method of analyzing features involved in a sample by electrophoresing the sample using a capillary and a sieving matrix, the method including: a reading step of reading an analysis condition; a sieving matrix filling step of filling the capillary with the sieving matrix; a sample injection step of injecting the sample into the capillary containing the sieving matrix charged in the sieving matrix filling step; an electrophoresing step of electrophoresing the sample in the sieving matrix, the sample being injected in the sample injection step; an abnormality determination step of statistically determining whether an analysis result obtained in the electrophoresing step is abnormal by comparing the analysis result with another analysis result obtained under the same analysis condition; and an analysis condition adjustment step of adjusting the analysis condition, where if the analysis result is determined to be abnormal in the abnormality determination step, the method proceeds to the reading step again after the analysis condition adjustment step is performed.

### TECHNICAL FIELD

The present invention relates to a capillary electrophoresis device and an analysis method using the capillary electrophoresis device.

### BACKGROUND ART

Recently, a capillary electrophoresis device, having a capillary filled with a sieving matrix such as a polymer gel or a polymer solution, has been widely used as an electrophoresis device. The capillary electrophoresis device allows automatic filling of the sieving matrix and automatic injection of a sample, enabling continuous analysis, and is thus used in a manner that multiple pieces of electrophoresis devices are pre-set to analyze a large number of samples all night.

A sample electrophoresed within the capillary is irradiated with laser, and a resulting signal is detected by a detection unit such as a CCD camera. In the case of high concentration of the sample injected into the capillary, however, the detected signal level is correspondingly high, and if the signal level exceeds a count threshold (for example, 65,535 counts) of the CCD camera, the signal is saturated, and a signal peak is indistinguishable. In this case, in the past, a user reprepares the sample by dilution or the like, or adjusts an assay (information for setting a condition of analysis operation and an analyzing condition) based on experience.

In the capillary electrophoresis device, an error may occur, i.e., the detection unit may detect no signal, or may detect only an extremely low signal. When such an error occurs, the user has also addressed the error based on experience, and has been most likely to select sample repreparation as a measure. However, the error such as no signal detection may be caused by sample injection failure in addition to a defective sample. If the error is caused by the sample injection failure, an appropriate signal can be detected by immediately performing electrophoresis before sample deterioration, making it possible to avoid sample repreparation, which is a heavy burden on the user.

Patent Literature 1 discloses an electrophoresis device, which prompts a user to change a parameter for sample concentration, sample injection, or the like when a signal is off-scale (saturated) or when the signal-to-noise ratio is lower. Patent Literature 1 also discloses that a low signal-to-noise ratio may indicate poor sample injection or the like, and thus the user is prompted to adjust the sample injection parameter.

### CITATION LIST

### Patent Literature

Patent Literature 1: US Patent Application Publication No. 2020/0003728

### SUMMARY OF INVENTION

### Technical Problem

In existing capillary electrophoresis devices, when finding an error, such as signal saturation or, conversely, an undetectable signal, the user has no choice but to determine how to address the error based on his or her own experience. If electrophoresis is performed continuously all night, the user does not notice an error that has occurred until early in the morning, and since the sample has deteriorated over time, electrophoresis is less likely to be performed again as it is even if the error is not caused by a defective sample. In such a case, the user must reprepare a sample, resulting in waste of time and effort, and a valuable sample.

Patent Literature 1 also discloses that the device modifies a sample injection parameter or the like when a signal is off-scale (saturated) or when a signal-to-noise ratio is lower, but does not disclose how the device specifically modifies the parameter or the like. In addition, in Patent Literature 1, since sample injection failure or the like is determined only by the signal-to-noise ratio, i.e., only by the signal height, If, for example, the signal-to-noise ratio is low for all data, electrophoresis will be performed again with the modified injection parameter for all samples. If the signal-to-noise ratio is low for all data, however, a defective sample or missing of sample injection is more likely to occur, rather than the sample injection failure, and thus such a low signal-to-noise ratio often cannot be solved simply by performing electrophoresis again. As a result, unnecessary electrophoresis may be performed, resulting in waste of the sieving matrix and time.

An object of the invention is to provide an analysis method, in which unnecessary re-electrophoresis and sample repreparation are suppressed.

### Solution to Problem

To achieve the object, the invention includes a method of analyzing features involved in a sample by electrophoresing the sample using a capillary and a sieving matrix, the method including: a reading step of reading an analysis condition; a sieving matrix filling step of filling the capillary with the sieving matrix; a sample injection step of injecting the sample into the capillary containing the sieving matrix charged in the sieving matrix filling step; an electrophoresing step of electrophoresing the sample in the sieving matrix, the sample being injected in the sample injection step; an abnormality determination step of statistically determining whether an analysis result obtained in the electrophoresing step is abnormal by comparing the analysis result with another analysis result obtained under the same analysis condition; and an analysis condition adjustment step of adjusting the analysis condition, where if the analysis result is determined to be abnormal in the abnormality determination step, the method proceeds to the reading step again after the analysis condition adjustment step is performed.

### Advantageous Effects of Invention

According to the invention, it is possible to provide an analysis method, in which unnecessary re-electrophoresis and sample repreparation are suppressed.

### BRIEF DESCRIPTION OF DRAWINGS

FIG. 1 is a perspective diagram showing an overview of a configuration of a capillary electrophoresis device.

FIG. 2 is a top view of the capillary electrophoresis device shown in FIG. 1.

FIG. 3 is a cross sectional diagram along line A-A of FIG. 2.

FIG. 4 is a flowchart showing an analysis method of the first embodiment.

FIG. 5 is a flowchart showing an analysis method of the second embodiment.

FIG. 6 is a graph showing an exemplary signal waveform in a saturated state.

FIG. 7 is a graph showing an enlarged view of the dotted line portion of FIG. 6.

FIG. 8 is a graph showing an image when a signal peak is estimated.

FIG. 9 is a graph showing an exemplary signal waveform in the case of sample injection failure.

FIG. 10 shows an exemplary plot of quality data (EQ) when sample injection failure occurs.

FIG. 11 shows an exemplary quality data (EQ) table when sample injection failure occurs.

FIG. 12 is a flowchart showing an analysis method of the third embodiment.

### DESCRIPTION OF EMBODIMENTS

One embodiment of the invention will now be described with reference to the drawings.

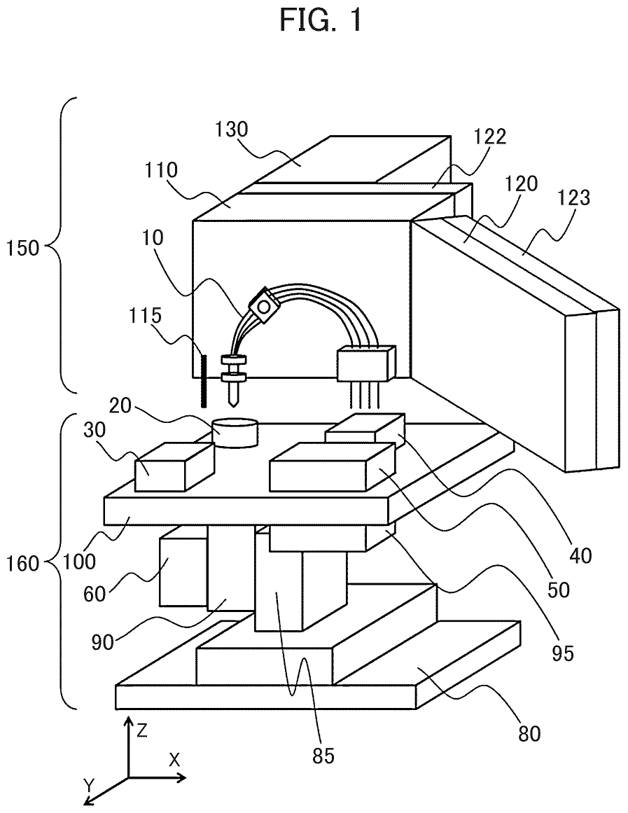

First, a configuration of a capillary electrophoresis device is described with reference to FIGS. 1 to 3. FIG. 1 is a perspective diagram showing an overview of a configuration of the capillary electrophoresis device. The capillary electrophoresis device is configured of two units: a detection/thermostatic oven unit 150 on the upper side and an autosampler unit 160 on the lower side.

In the autosampler unit 160, a Y-axis mover 85 is mounted on a sampler base 80 to allow movement along the Y-axis. A Z-axis mover 90 is mounted on the Y-axis mover 85 to allow movement along the Z-axis. A sample tray 100 is mounted on the Z-axis mover 90, and a sieving matrix container 20, an anode-side buffer solution container 30, a cathode-side buffer solution container 40, and a sample container 50 are set on the sample tray 100 by a user. The sample container 50 is set on an X-axis mover 95 mounted on the sample tray 100 and can thus move along the X-axis on the sample tray 100. A liquid feeding mechanism 60 is also mounted on the Z-axis mover 90. The liquid feeding mechanism 60 is disposed below the sieving matrix container 20.

The detection/thermostatic oven unit 150 includes a thermostatic oven unit 110 and a thermostatic oven door 120, and can maintain the inside of the thermostatic oven unit 110 at a constant temperature. The detection/thermostatic oven unit 150 further includes a detection unit 130 behind the thermostatic oven unit 110, and thus can apply laser and detect a signal generated during such laser application. When a capillary array 10 is set in the thermostatic oven unit 110 by a user, a sample is electrophoresed in the thermostatic oven unit 110 while a capillary array 10 is maintained at a constant temperature. At this time, the detection unit 130 detects, with a CCD camera or the like, a signal generated when the sample is irradiated with the laser while being electrophoresed within the capillary array 10. The thermostatic oven unit 110 also has an electrode 115 for grounding when a high voltage is applied for electrophoresis.

As described above, the capillary array 10 is fixed to the thermostatic oven unit 110. The sieving matrix container 20, the anode-side buffer solution container 30, the cathode-side buffer solution container 40, and the sample container 50 can be moved along the Y-axis and the Z-axis by the autosampler unit 160, and only the sample container 50 can be moved even along the X-axis. The autosampler unit 160 moves to automatically connect the sieving matrix container 20, the anode-side buffer solution container 30, the cathode-side buffer solution container 40, and the sample container 50 to the fixed capillary array 10.

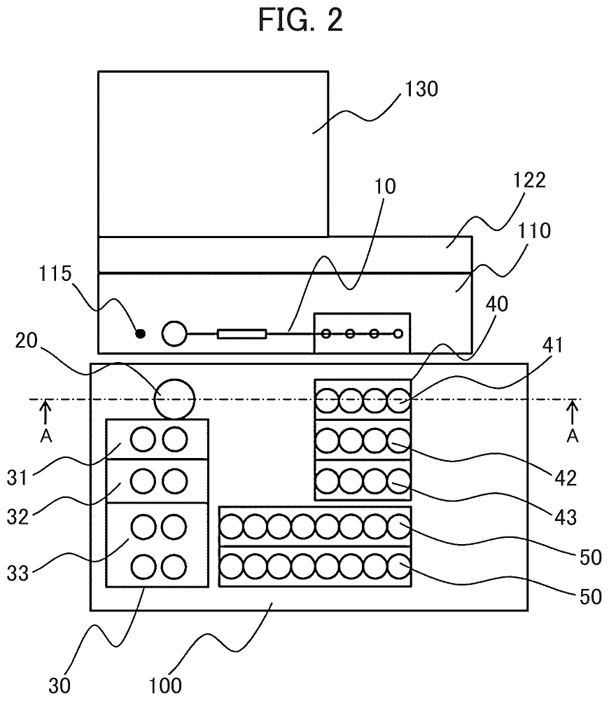

FIG. 2 is a top view of the capillary electrophoresis device shown in FIG. 1. The anode-side buffer solution container 30 set on the sample tray 100 contains an anode-side washing tank 31, an anode-side electrophoresis buffer solution tank 32, and a sample introduction buffer solution tank 33. The cathode-side buffer solution container 40 set on the sample tray 100 contains a waste liquid tank 41, a cathode-side cleaning tank 42, and a cathode-side electrophoresis buffer solution tank 43.

The sieving matrix container 20, the anode-side buffer solution container 30, the cathode-side buffer solution container 40, and the sample container 50 are arranged on the sample tray 100 in a positional relationship shown in FIG. 2. As a result, the anode-side/cathode-side combinations to be connected to the capillary array 10 include “sieving matrix container 20/waste tank 41”, “anode-side washing tank 31/cathode-side washing tank 42”, “anode-side electrophoresis buffer solution tank 32/cathode-side electrophoresis buffer solution tank 43”, and “sample introduction buffer solution tank 33/sample container 50”.

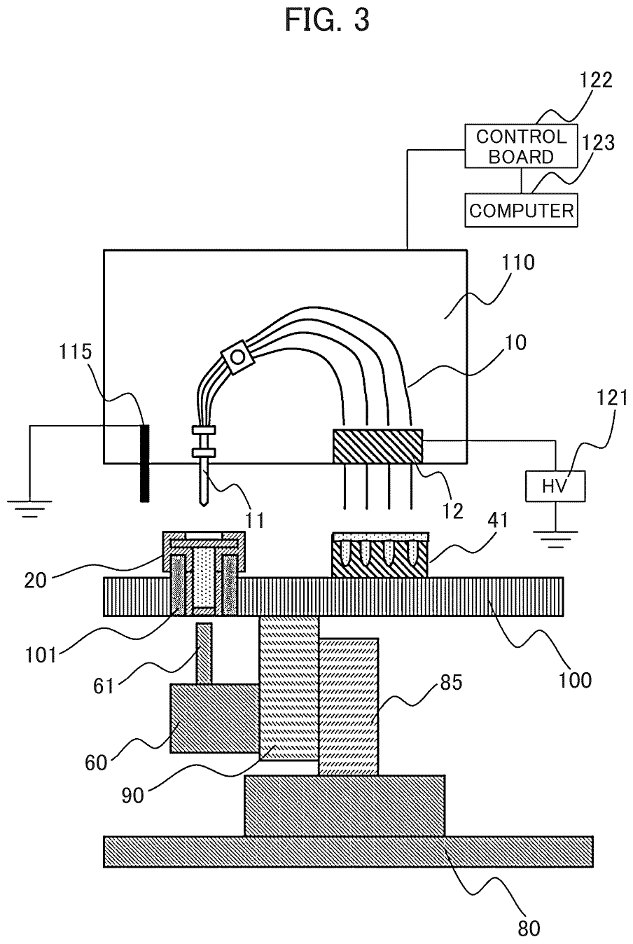

FIG. 3 is a cross sectional diagram along line A-A of FIG. 2, showing a cross section of the capillary electrophoresis device where the anode-side/cathode-side combination to be connected to the capillary array 10 is “sieving matrix container 20/waste tank 41”. The sieving matrix container 20 is inserted into a guide 101 embedded in the sample tray 100 and set therein. The liquid feeding mechanism 60 is disposed so that a plunger 61 built in the liquid feeding mechanism 60 is located below the sieving matrix container 20. During electrophoresis, the right side of the capillary array 10 in FIG. 3 is the cathode side, and the left side thereof is the anode side.

The capillary electrophoresis device is controlled by a control section. The control section includes a control board 122 and a computer 123 connected to the control board 122. Although the control board 122 is located on the back side of the thermostatic oven unit 110, and the computer 123 is located on the outer side (front side) of the thermostatic oven door 120 in the exemplary case of FIG. 1, such locations are not limited thereto. According to instructions from the computer 123, the control board 122 controls operations of the high-voltage power supply 121, the thermostatic oven unit 110, the detection unit 130, and the like. The computer 123 calculates analysis results based on the signals detected by the detection unit 130, and has an input section to input settings (including an assay described later), etc., of the capillary electrophoresis device, and an output section (display section) to display analysis results, and the like. The analysis results may be calculated by the control board 122.

### First Embodiment

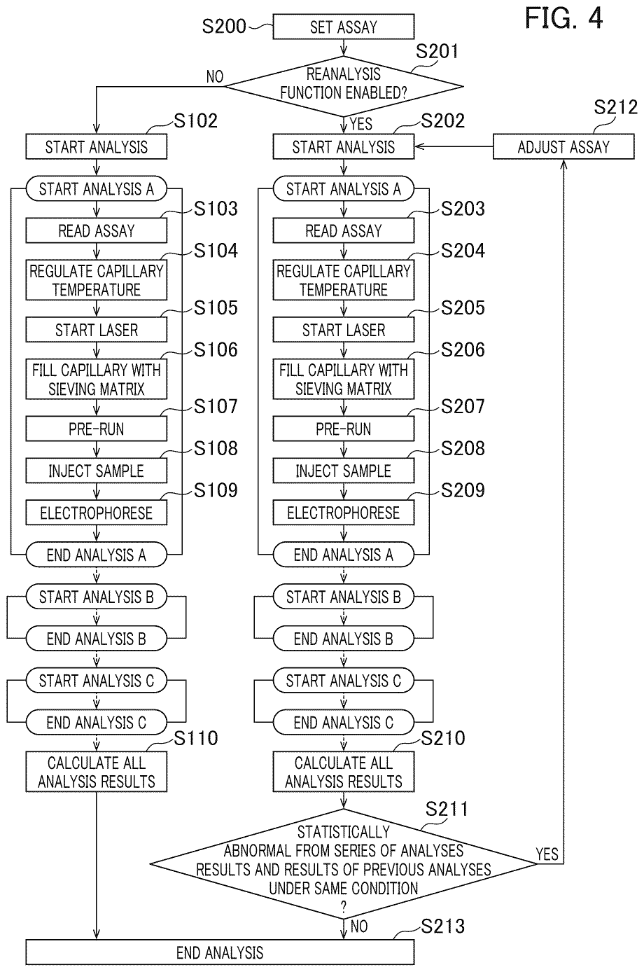

A flow of a series of analyses performed by the capillary electrophoresis device according to the present embodiment is described with reference to FIG. 4. FIG. 4 is a flowchart showing the analysis method of the first embodiment.

First, a user uses the input unit to set an assay to be used in the series of analyses (step S200). The assay refers to information that defines an operating condition for analysis and an analyzing condition. The operating condition includes laser power of the detection unit 130, temperature of the thermostatic oven unit 110, a type of the sieving matrix, voltage applied in pre-run described later and application time of the voltage, voltage applied in a sample injection step described later and application time of the voltage, voltage applied in an electrophoresing step and application time of the voltage, laser irradiation time and a sampling period during data acquisition, and the like. The analyzing condition includes analyzing width specified by data points or size of bases, a signal height threshold, a base call mobility file set to read a sequence in the case of sequencing analysis, fragment size used in analyzing in the case of fragment analysis, and the like.

Subsequently, when the analysis result is determined to be abnormal, the user sets a function for performing reanalysis (reanalysis function) as needed. The control section determines whether the reanalysis function is enabled (step S201), and if determining it to be not enabled, performs steps S102 to S110. On the other hand, if determining the reanalysis function to be enabled in step S201, the control section performs steps S202 to S212. Since steps S102 to S110 are the same as steps S202 to S210, only steps S202 to S210 will be described below.

When the analysis method is started in step S202, the series of analyses are performed. In the present embodiment, one analysis is defined as a process from sample injection to the end of one electrophoresis by voltage application. In other words, the user can pre-set not only one analysis, but also multiple series of analyses. In the following, a case, in which three analyses, analysis A, analysis B, and analysis C, are pre-set, is exemplarily described, but the number of analyses is not limited thereto.

When the first analysis, analysis A, is started, the control section performs a step of reading the assay set in step S200 (assay reading step) (step S203).

Subsequently, the control section controls the thermostatic oven unit 110 to perform a step of maintaining the capillary array 10 at a constant temperature (capillary temperature regulation step) (step S204).

Subsequently, the control section starts a laser of the detection unit 130 (step S205).

Furthermore, the control section controls the autosampler unit 160 and the plunger 61 to perform a step of filling the capillary array 10 with the sieving matrix contained in the sieving matrix container 20 (sieving matrix filling step) (step S206). The sieving matrix filling step is now described in more detail. First, the autosampler unit 160 moves so that the anode-side/cathode-side combination to be connected to the capillary array 10 is “sieving matrix container 20/waste tank 41”. Subsequently, a capillary head 11, which is the anode-side end of the capillary array 10, is inserted into the sieving matrix container 20, and a load header 12, which is the cathode-side end of the capillary array 10, is inserted into the waste liquid tank 41. In this state, the plunger 61 built in the liquid feeding mechanism 60 moves upward, and the sieving matrix contained in the sieving matrix container 20 is fed into the capillary array 10 through the capillary head 11. If the capillary array 10 has been filled with the sieving matrix before liquid feeding, or if the sieving matrix is sufficiently fed into the capillary array 10 and remains in excess, the sieving matrix is discharged from the load header 12 into the waste tank 41.

Subsequently, the control section performs pre-run (step S207). Specifically, first, the autosampler unit 160 moves so that the anode-side/cathode-side combination to be connected to the capillary array 10 is “anode-side electrophoresis buffer solution tank 32/cathode-side electrophoresis buffer solution tank 43”. Subsequently, the capillary head 11 is inserted into the anode-side electrophoresis buffer solution tank 32, and the load header 12 is inserted into the cathode-side electrophoresis buffer solution tank 43. In this state, the high-voltage power supply 121 applies a high voltage to the capillary array 10. The pre-run is the same as the electrophoresis after sample injection as described later, but is performed before sample injection to stabilize electrophoresis performance.

After that, the control section performs a step of injecting the sample set in the sample container 50 into the capillary array 10 (sample injection step) (step S208). Specifically, first, the autosampler unit 160 moves so that the anode-side/cathode-side combination to be connected to the capillary array 10 is “sample introduction buffer solution tank 33/sample container 50”. Subsequently, the capillary head 11 is inserted into the sample introduction buffer solution tank 33, and the load header 12 is inserted into the sample container 50. In this state, the high-voltage power supply 121 applies a high voltage to the capillary array 10. As a result, the negatively charged sample is injected from the load header 12 into the capillary array 10.

A cleaning step may be performed to clean the capillary head 11 and the load header 12, corresponding to both ends of the capillary array 10, before or after the sieving matrix filling step or the sample injection step. In this case, first, the autosampler unit 160 moves so that the anode-side/cathode-side combination to be connected to the capillary array 10 is “anode-side cleaning tank 31/cathode-side cleaning tank 42”. Subsequently, the capillary head 11 is inserted into the anode-side cleaning tank 31, and the load header 12 is inserted into the cathode-side cleaning tank 42. The capillary array 10 is left in that state for a few seconds, making it possible to clean the two ends thereof.

Subsequently, the control section performs a step of applying a voltage to the capillary array 10, into which the sample has been injected, to electrophorese the sample (electrophoresing step) (step S209). Specifically, first, the autosampler unit 160 moves so that the anode-side/cathode-side combination to be connected to the capillary array 10 is “anode-side electrophoresis buffer solution tank 32/cathode-side electrophoresis buffer solution tank 43”. Subsequently, the capillary head 11 is inserted into the anode-side electrophoresis buffer solution tank 32, and the load header 12 is inserted into the cathode-side electrophoresis buffer solution tank 43. In this state, the high-voltage power supply 121 applies a high voltage to the capillary array 10. As a result, a high voltage is applied to the capillary array 10 on the cathode side to flow a current to ground through the electrode 115 via the cathode-side buffer solution container 40 and the anode-side buffer solution container 30, so that electrophoresis is performed. In the electrophoresing step, the sample, which flows through the capillary array 10 in molecular size order due to the molecular sieving effect of the sieving matrix, are detected by the detection unit 130. The voltage application by the high-voltage power supply 121 and the signal detection by the detection unit 130 continue for a predetermined time defined in the assay set in step S200.

When the electrophoresis has been performed for a predetermined time in step S209, the first analysis, analysis A, is completed, and the second analysis, analysis B, is started. In the analysis B, steps S203 to S209 are also performed as with the previous analysis A. When the analysis B has been completed, the third analysis, analysis C, is started. In the analysis C, steps S203 to S209 are also performed as with the analyses A and B.

When the series of analyses including the analyses A, B, and C are all completed, the control section calculates all the analysis results (step S210). If the reanalysis function is not enabled in step S201, once all the analysis results are calculated, the analysis method ends (step S213).

If the reanalysis function is enabled in step S201, once all analysis results have been calculated, the control section performs a step (abnormality determination step) to statistically determine whether any abnormal analysis result is included based on the calculated analysis results on the series of analyses and the results of previous analyses performed under the same condition (assay) (step S211). For example, if the result of the analysis B has significantly smaller value than each of the results of other analyses A and C, the result of the analysis B is determined to be statistically abnormal. A significantly small value among values of a plurality of analysis results may be determined as an outlier obtained by the Smirnov-Grubbs test, for example.

The analysis results used for the determination in step S211 include quality data, in addition to the signal height data detected by the detection unit 130. In fragment analysis, the quality data refers to EQ, which indicates the maximum base length within a range allowing one base separation, and in sequencing analysis, the quality data refers to QV 20CRL, which indicates the maximum continuous base length with the average QV value (base call reliability) of more than 99% in a window of 20 bp of the decoded sequence, the window having been slid from the short base side to the long base side.

If a statistically abnormal analysis result is determined to be included in step S211, the control section performs a step of creating a new assay for the objective analysis (first assay adjustment step) (step S212). Creating the new assay means adjusting the assay that has been initially set up.

Subsequently, the control section returns to step S202 and starts reanalysis for the analysis with an abnormal result. For example, if the subject of the abnormality is the analysis B, the control section operates the high-voltage power supply 121 etc. based on the adjusted assay for the analysis B, injects a sample corresponding to the analysis B into the capillary array 10, and reanalyzes only for the analysis B. When the reanalysis is completed, the analysis results are calculated again in step S210, and it is determined in step S211 whether the results are statistically abnormal. If the results are determined to be not abnormal in step S211, the analysis method ends (step S213).

As described above, in the present embodiment, if the results of the series of analyses contain abnormality, the capillary electrophoresis device adjusts the assay itself and performs reanalysis. Even if the sample injection failure occurs, therefore, an appropriate signal can be detected by immediately performing electrophoresis before the sample deteriorates. This makes it possible to avoid sample repreparation, which places a heavy burden on the user.

### Second Embodiment

In the first embodiment, if a statistically abnormal analysis result is found in the abnormality determination step, the first assay adjustment step is performed, but in the second embodiment, even if a statistically abnormal analysis result is found in the abnormality determination step, the first assay adjustment step is not performed, and reanalysis is performed with the same assay. Furthermore, in the second embodiment, unlike the first embodiment, signal saturation is determined based on signal height data detected by the detection unit 130, and if the signal is saturated, a second assay adjustment step is performed for reanalysis with a new assay. Furthermore, in the first embodiment, the sample injection failure is determined only in the abnormality determination step, but in the second embodiment, the sample injection failure is determined not only in the abnormality determination step but also in a step of comparing the signal height data with a threshold (signal height determination step).

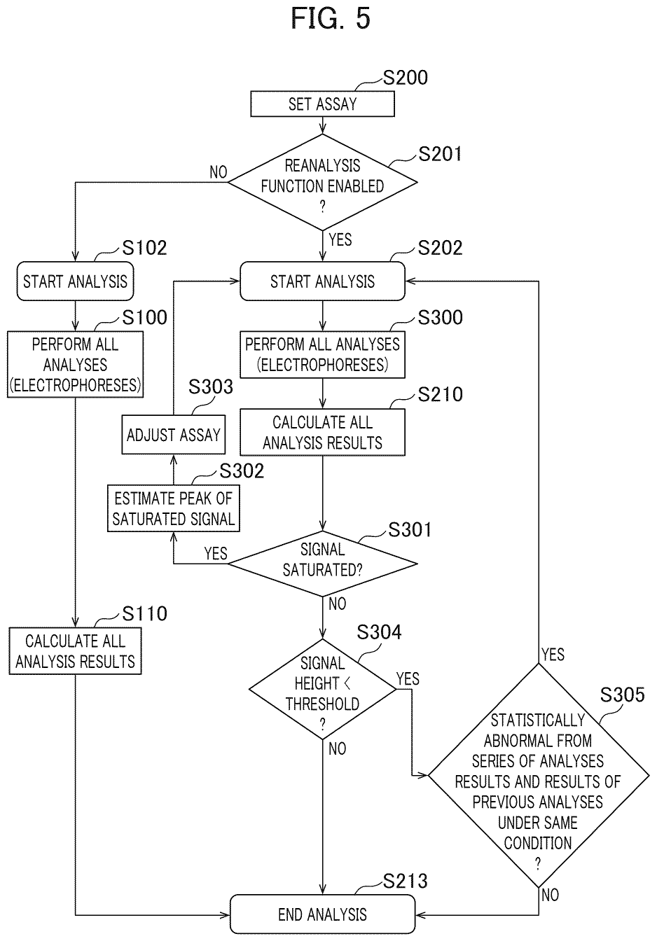

The flow of a series of analyses performed by the capillary electrophoresis device according to the present embodiment is now described with reference to FIG. 5. FIG. 5 is a flowchart showing the analysis method of the second embodiment.

First, a user uses the input unit to set an assay to be used in the series of analyses (step S200).

Subsequently, the user sets a reanalysis function as needed. The control section determines whether the reanalysis function is enabled (step S201), and if it is not enabled, once analysis is started (step S102), it performs steps S103 to S109 in FIG. 4 of the first embodiment for all analyses (step S100). On the other hand, if the reanalysis function is enabled in step S201, once analysis is started (step S202), the control section performs steps S202 to S209 in FIG. 4 of the first embodiment for all analyses (step S300). When all the series of analyses have been finished, the control section calculates results of all the analyses (step S210). If the reanalysis function is not enabled in step S201, once all the analysis results are calculated, the analysis method ends (step S213).

If the reanalysis function is enabled in step S201, once all the analysis results are calculated, the control section performs a step of determining whether a signal is saturated (signal saturation determination step) (step S301). The signal height data detected by the detection unit 130 in the electrophoresing step is used in the signal saturation determination step.

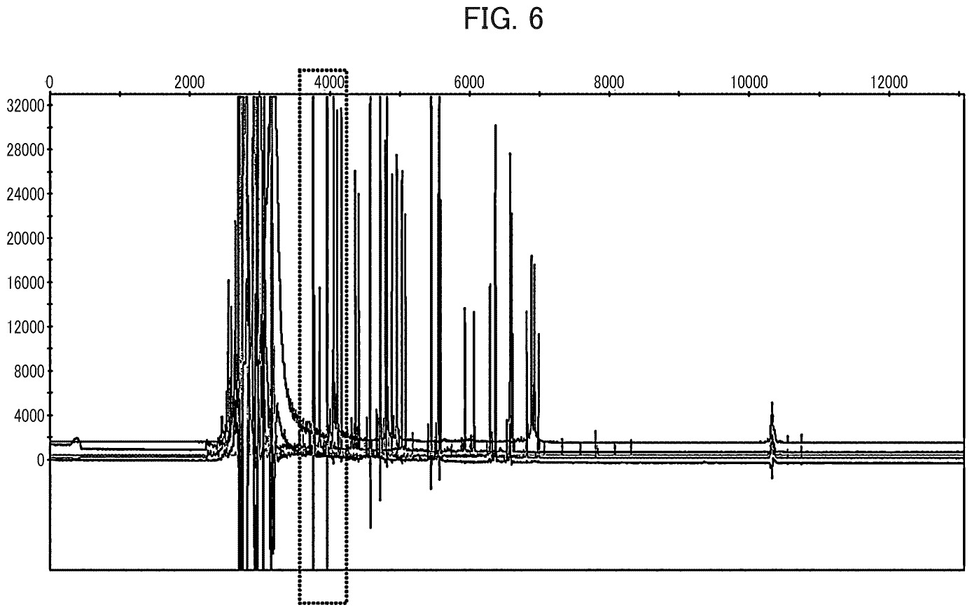

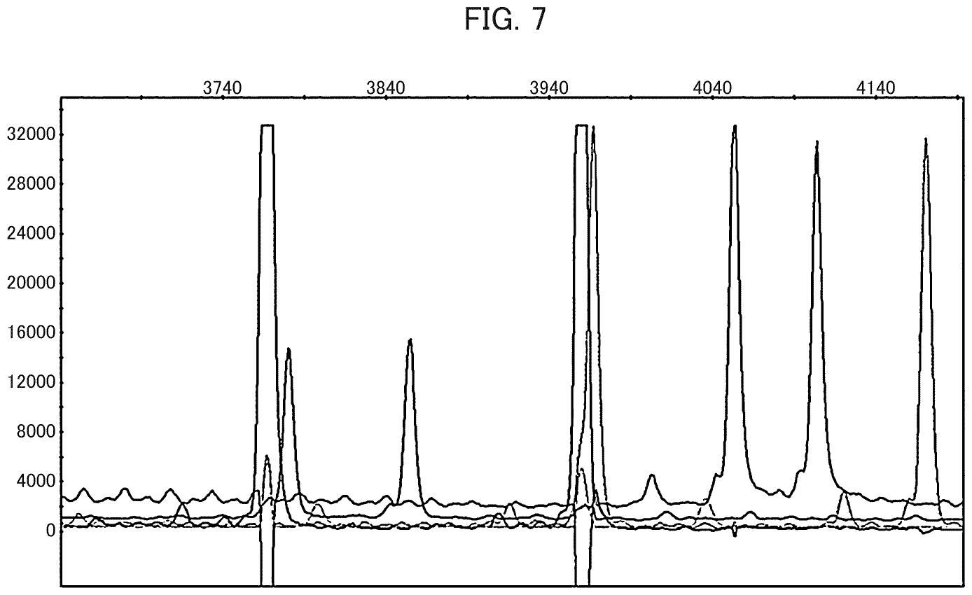

FIG. 6 is a graph showing an exemplary signal waveform in a saturated state, and FIG. 7 is a graph showing the dotted line portion of FIG. 6 in an enlarged manner. In FIGS. 6 and 7, the horizontal axis is in units of the number of data points of the CCD camera, and the vertical axis is in units of RFU for signal height (signal intensity). As shown in FIGS. 6 and 7, once the signal is saturated, a signal peak is less likely to be visually identified.

If the signal is determined to be saturated in step S301, therefore, the control section performs a step of estimating a peak of a signal waveform (signal peak estimation step) (step S302). At this time, the control section approximates the peak by fitting with the Gaussian function, Lorentzian function, or the like from a skirt part of a signal-saturated waveform and a waveform before or after the peak.

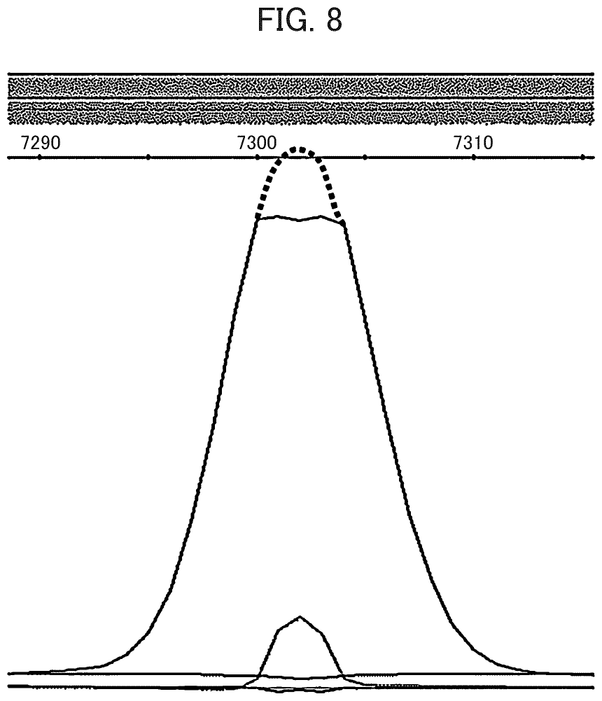

FIG. 8 is a graph showing an image in estimation of a signal peak. As shown by the dotted line of FIG. 8, the signal height is estimated through peak approximation while it has been invisible due to saturation.

Subsequently, the control section performs a step of adjusting the assay to prevent signal saturation (second assay adjustment step) based on the peak of the saturated signal estimated in step S302 (step S303).

The second assay adjustment step is now described with a specific example. Signal saturation is assumed to occur when an original sample injection voltage using an unadjusted assay is 1.6 kV. The peak signal intensity estimated by fitting with the Gaussian function in step S302 is assumed to be 50,000 RFU. It is further assumed that the user sets an unsaturated signal height of 20,000 RFU as a target value. When the detection unit 130 includes a CCD camera, the unsaturated signal height should be approximately half the count threshold or less (for example, approximately 30,000 or less when the count threshold is 65,535 counts), and the user can set any signal height as the target value within this range.

If 20,000 RFU is set as the unsaturated signal height, the control section determines an adjustment factor of 0.4 from 20,000 RFU divided by 50,000 RFU. The control section multiplies the original sample injection voltage by this adjustment factor, i.e., 0.4×1.6 kV, to obtain a new, adjusted sample injection voltage of 0.64 kV. As a result, the control section creates a new assay with a changed sample injection voltage of 0.64 kV.

Although the assay has been adjusted by changing the sample injection voltage in the specific example, the assay may be adjusted by changing analysis conditions other than the sample injection voltage, such as sample injection time (voltage application time), laser irradiation time, and laser power. In each case, the control section adjusts the assay by multiplying the parameter value of the original analytical condition by the same adjustment factor.

Once the assay is adjusted, the control section returns to step S202, and performs reanalysis based on the adjusted assay. Thus, even if the user cannot visually check the signal peak due to signal saturation, the peak is automatically estimated and reanalysis is performed based on the new assay, making it possible to acquire data while avoiding signal saturation without unnecessarily repeating electrophoresis. As a result, it is possible to prevent waste of the sieving matrix and time.

Subsequently, if the signal is determined to be not saturated in step S301, the control section performs a step of determining whether signal height is less than a predetermined threshold (signal height determination step) (step S304). If the signal height is less than the threshold, the sample injection failure may occur.

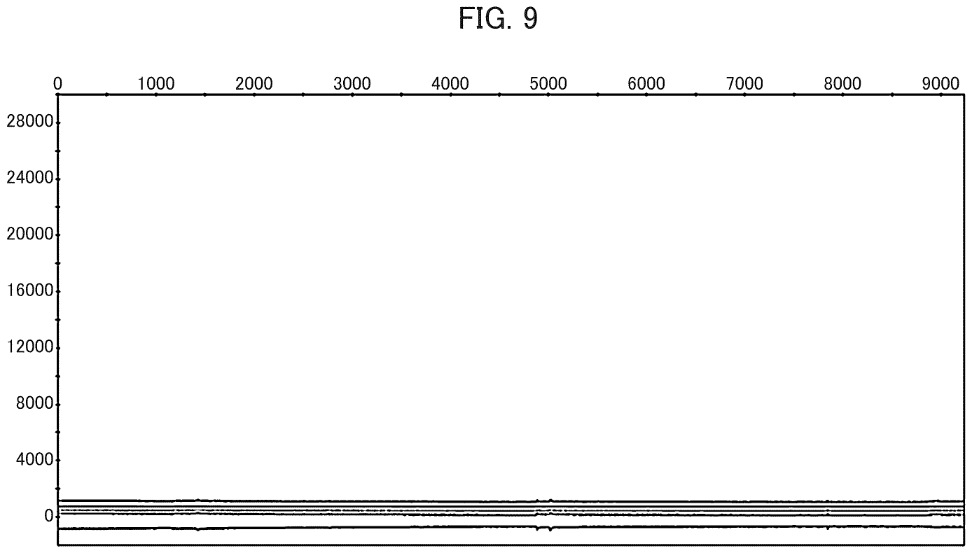

FIG. 9 is a graph showing an exemplary signal waveform in the case of sample injection failure. In FIG. 9, the horizontal axis is in units of the number of data points, and the vertical axis is in units of RFU. As shown in FIG. 9, only the baselines are output, and no sample-induced signal is observed. Although no signal is observed in FIG. 9, there may be a case of a signal that is partly extremely low. The threshold used in the signal height determination step is set to, for example, 100 RFU in consideration of noise. The threshold may be determined based on a signal-to-noise ratio instead of signal height.

If the signal height is determined to be less than the threshold in step S304, the control section performs a step (abnormality determination step) of statistically determining whether an abnormal analysis result is included based on results of the series of analyses, etc. (step S305).

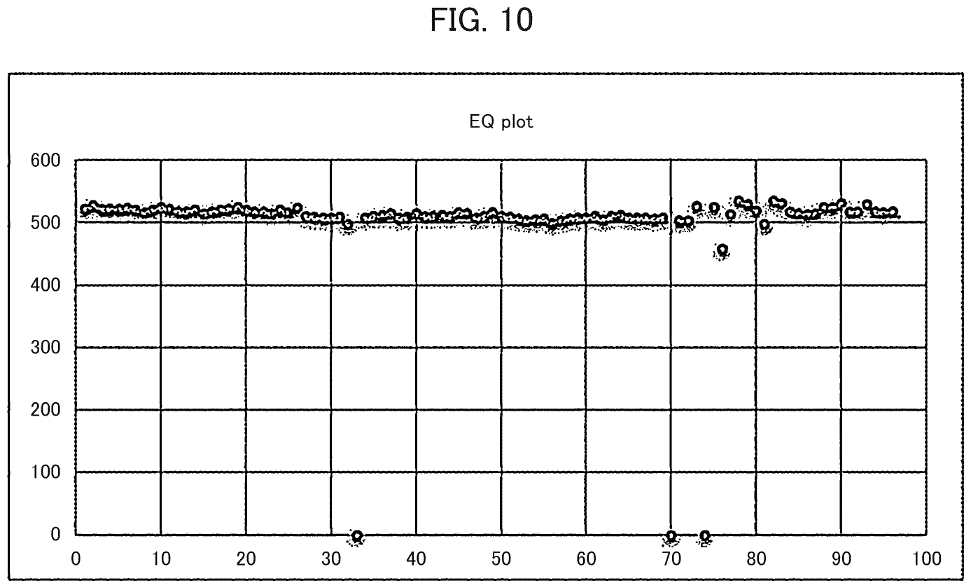

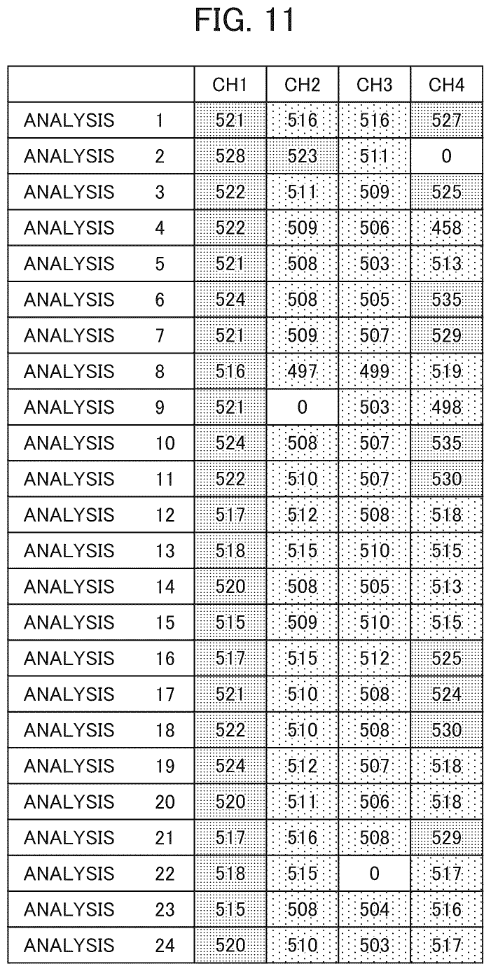

FIG. 10 shows an exemplary plot of quality data (EQ) when sample injection failure occurs, and FIG. 11 is an exemplary table of quality data (EQ) when sample injection failure occurs. FIG. 11 shows data obtained by repeating the analysis 24 times with the capillary array 10 having four load headers 12. In FIG. 11, the four load headers 12 are represented as CH1, CH2, CH3, and CH4. In FIG. 10, the same data as in FIG. 11 are used, and all data are plotted linearly regardless of the four road headers 12. While most of the data from analysis-1 to analysis-24 show approximately between EQ 450 and EQ 535, some data show EQ of 0. Zero is an example of an outlier, and the data of CH4 in analysis-2, CH2 in analysis-9, and CH3 in analysis-22 are statistically determined to be more likely to show sample injection failure because they are significantly smaller than the other data in the series. The outlier may be determined using the Smirnov-Grubbs test.

In this way, accuracy of error determination is improved by comparing individual data with other data to determine whether the data is statistically abnormal, rather than comparing the data with a single threshold. For example, if all data show low signal height, since it is likely that there is some other error, such as a defective sample or missing of sample injection, rather than the sample injection failure, re-electrophoresis is not an effective measure. However, if the signal height is low only in some of the data, there is likely to be the sample injection failure, and re-electrophoresis is an effective measure. The control section therefore reanalyzes only the samples for analysis-2, analysis-9, and analysis-22. The assay used for such reanalysis may be the same as the initially set assay. This is because if the sample injection failure is caused by air bubbles, the air bubbles may be removed even by re-electrophoresis under the same conditions, resulting in normal sample injection.

In the present embodiment, results of a certain analysis are compared with results of other analyses included in a series of analyses performed 24 times (analysis-1 to analysis-24) to statistically determine whether the results are abnormal. However, the results of a certain analysis may also be compared with results of previous analyses performed under the same condition (assay), rather than the results of the series of analyses, to statistically determine whether the results are abnormal.

If the signal height is determined to be equal to or higher than the threshold in step S304 as a result of the re-electrophoresis, the analysis method ends (step S213).

### Third Embodiment

In the second embodiment, if a statistically abnormal analysis result is found in the abnormality determination step, reanalysis is performed using the same assay, and if an abnormal analysis result is also found in the abnormality determination step after the reanalysis, reanalysis is repeated using the same assay. In the third embodiment, however, if a statistically abnormal analysis result is found in the first abnormality determination step, reanalysis is performed using the same assay, and if a statistically abnormal analysis result is also found in the second abnormality determination step, a first assay adjustment step is performed. In addition, in the third embodiment, reanalysis is performed using the adjusted assay, and if a statistically abnormal analysis result is found even in the third abnormality determination step, a step is performed to output a display for prompting the user to reprepare the sample (repreparation display step).

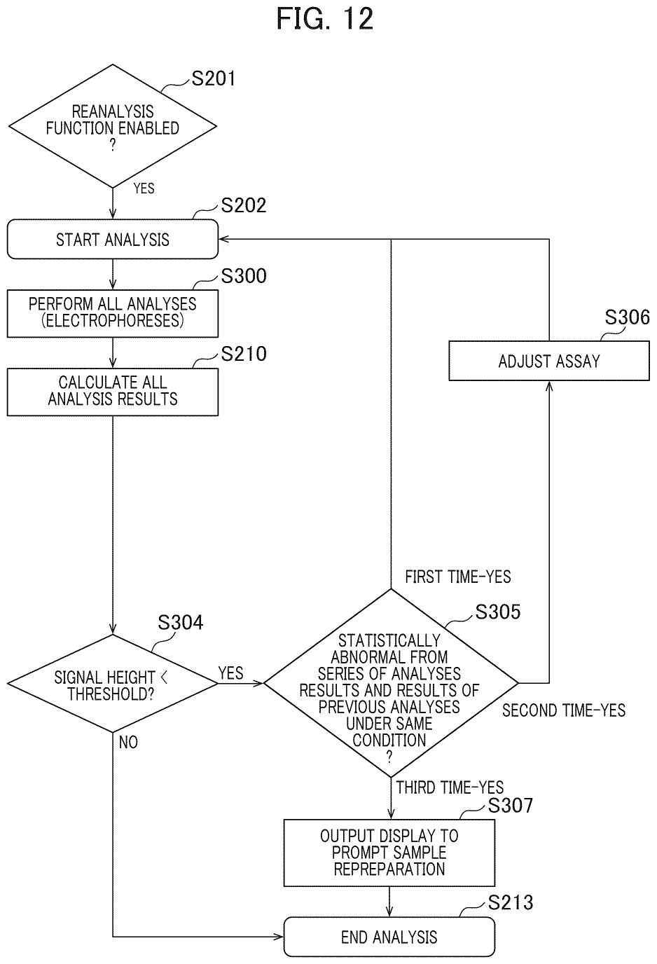

A flow of a series of analyses performed by the capillary electrophoresis device according to the present embodiment is now described with reference to FIG. 12. FIG. 12 is a flowchart showing the analysis method of the third embodiment. In FIG. 12, however, steps S200, S102, S100, S110, S302, and S303 in FIG. 5 (second embodiment) are omitted. In the following, only the differences from the second embodiment are described.

In step S305, if a statistically abnormal analysis result is found in the first abnormality determination step, the control section does not adjust the assay and returns to step S202, and performs reanalysis based on the initially set assay. In step S305, if a statistically abnormal analysis result is also found in the second abnormality determination step, the control section performs a first assay adjustment step (step S306).

The first assay adjustment step is now described with a specific example. It is assumed that when an original sample injection voltage using an unadjusted assay is 1.6 kV, a statistically abnormal analytical result is given. It is further assumed that a value of 10 is set as an adjustment factor for increasing signal strength, for example. In this case, the control section multiplies the original sample injection voltage by the adjustment factor, i.e., 10×1.6 kV, to obtain a new, adjusted sample injection voltage of 16 kV. As a result, the control section creates a new assay with an updated sample injection voltage of 16 kV.

Although the assay has been adjusted by changing the sample injection voltage in the specific example, the assay may be adjusted by changing analysis conditions other than the sample injection voltage, such as sample injection time (voltage application time), laser irradiation time, and laser power. In each case, the control section adjusts the assay by multiplying the parameter value of the original analytical condition by the same adjustment factor.

When the assay is adjusted in the first assay adjustment step, the control section returns to step S202, and performs reanalysis based on the adjusted assay. If a statistically abnormal analysis result is found even in the third abnormality determination step in step S305, a defective sample, rather than sample injection failure, is likely to occur. The control section therefore performs a step of outputting, on the display section, a display to prompt sample repreparation (repreparation display step) (step S307), and the analysis method ends (step S213). Although not shown in FIG. 12, if no statistically abnormal analysis result is found in step S305, the analysis method also ends (step S213).

According to the present embodiment, it is possible to address the sample injection failure by automatically performing reanalysis while avoiding sample repreparation as much as possible. Although reanalysis is performed once using the same assay and performed once using the adjusted assay in the third embodiment, each reanalysis may be performed multiple times as long as the sample does not deteriorate.

Although the invention has been described with the first to the third embodiments hereinbefore, the invention is not limited thereto, and various modifications can be made.

For example, although a statistical determination is made using quality data (EQ) in the abnormality determination step in the second embodiment, the statistical determination may be made using signal height data. In one example of determination using the signal height data, when most signal height data are each about 10,000 RFU, a signal height data of about 300 RFU is determined to be abnormal. Furthermore, in the abnormality determination step, a statistical determination may be made using both the quality data and the signal height data.

The capillary electrophoresis device of the first embodiment determines statistical abnormalities to perform reanalysis for addressing sample injection failure, and the capillary electrophoresis devices of the second and the third embodiments each perform reanalysis to address signal saturation in addition to the sample injection failure. However, the capillary electrophoresis device may be one that does not address sample injection failure but only addresses signal saturation.

### LIST OF REFERENCE SIGNS

10: capillary array
11: capillary head
12: load header
20: sieving matrix container
30: anode-side buffer solution container
31: anode-side washing tank
32: anode-side electrophoresis buffer solution tank
33: sample introduction buffer solution tank
40: cathode-side buffer solution container
41: waste liquid tank
42: cathode-side cleaning tank
43: cathode-side electrophoresis buffer solution tank
50: sample container
60: liquid feeding mechanism
61: plunger
80: sampler base
85: y-axis mover
90: z-axis mover
95: x-axis mover
100: sample tray
101: guide
110: thermostatic oven unit
115: electrode
120: thermostatic oven door
121: high-voltage power supply
122: control board
123: computer
130: detection unit
150: detection/thermostatic oven unit
160: autosampler unit

1. A method of analyzing features involved in a sample by electrophoresing the sample using a capillary and a sieving matrix, the method comprising:
a reading step of reading an analysis condition;
a sieving matrix filling step of filling the capillary with the sieving matrix;
a sample injection step of injecting the sample into the capillary containing the sieving matrix charged in the sieving matrix filling step;
an electrophoresing step of electrophoresing the sample in the sieving matrix, the sample being injected in the sample injection step;
a signal height determination step of determining whether a signal height detected by a detection unit during application of laser light in the electrophoresing step is less than a predetermined threshold;
an abnormality determination step of statistically determining whether an analysis result obtained in the electrophoresing step is abnormal by comparing the analysis result with another analysis result obtained under the same analysis condition; and
an analysis condition adjustment step of adjusting the analysis condition,
wherein if the signal height is determined to be less than the predetermined threshold in the signal height determination step, and if the analysis result is determined to be abnormal in the abnormality determination step, in the analysis condition adjustment step, an application condition of a voltage to the capillary by a power supply during injection of the sample or an application condition of the laser light by the detection unit is adjusted to a condition under which intensity of a signal detected by the detection unit increases, and then the method proceeds to the reading step again.

2. The method according to claim 1, further comprising:
a signal saturation determination step of determining whether the signal detected in the electrophoresing step is saturated; and
a signal peak estimation step of estimating a peak of a signal waveform when the signal is determined to be saturated in the signal saturation determination step,
wherein in the analysis condition adjustment step, the analysis condition is adjusted based on the peak estimated in the signal peak estimation step to an analysis condition under which no signal is saturated.

3. The method according to claim 1,
wherein even if the analysis result is determined to be abnormal in the abnormality determination step, the method proceeds to the reading step while the analysis condition adjustment step is not performed, and if the analysis result is determined to be abnormal again in the abnormality determination step, the method proceeds to the reading step after the analysis condition adjustment step is performed.

4. The method according to claim 1, further comprising
a repreparation display step of outputting a display to prompt repreparation of the sample,
wherein after proceeding to the reading step after the analysis condition adjustment step is performed, if the analysis result is determined to be abnormal again in the abnormality determination step, the method proceeds to the repreparation display step.

5. A capillary electrophoresis device, comprising:
a capillary to be filled with a sieving matrix;
a power supply that applies a voltage to the capillary to electrophorese a sample; and a detection unit that detects a signal when laser is applied to the sample being electrophoresed in the capillary; and
a control section that controls operations of the power supply and the detection unit, and calculates an analysis result,
wherein the control section:
determines whether a signal height detected by the detection unit is less than a predetermined threshold, and compares the calculated analysis result with another analysis result obtained under the same analysis condition and thus statistically determines whether the calculated analysis result is abnormal; and
when determining the signal height to be less than the predetermined threshold, and when determining the analysis result to be abnormal, adjusts an application condition of a voltage to the capillary by the power supply during injection of the sample or an application condition of the laser light by the detection unit to a condition under which intensity of the signal detected by the detection unit increases, and operates the power supply and the detection unit under the adjusted analysis condition and performs reanalysis.

6. The capillary electrophoresis device according to claim 5,
wherein when the signal detected by the detection unit is saturated, the control section estimates a peak of a signal waveform, and adjusts the analysis condition based on the estimated peak to an analysis condition under which no signal is saturated.

7. The capillary electrophoresis device according to claim 6,
wherein when the signal detected by the detection unit is saturated, the control section adjusts an application condition of the voltage to the capillary by the power supply during injection of the sample or an application condition of the laser by the detection unit, and thus decreases intensity of the signal detected by the detection unit.

8. (canceled)

9. The capillary electrophoresis device according to claim 5,
wherein even if determining the analysis result to be abnormal, the control section reanalyzes the sample under the same analysis condition, and if determining a result of the reanalysis to be abnormal again, reanalyzes the sample under the adjusted analysis condition.

10. The capillary electrophoresis device according to claim 5, further comprising
a display section that displays an analysis result,
wherein when determining the analysis result to be abnormal even if reanalyzing the sample under the adjusted analysis condition, the control section outputs a display to prompt sample repreparation to the display section.
